(19) United States
(12) Patent Application Publication
(10) Pub. No.: US 2026/0076412 A1
(43) Pub. Date: Mar. 19, 2026

(54) ATOMIZING CORE AND ATOMIZING DEVICE

(71) Applicant: SMOORE INTERNATIONAL HOLDINGS LIMITED, Grand Cayman (KY)

(72) Inventors: Liqing ZHENG, Shenzhen (CN); Shuting CHEN, Shenzhen (SG); Wei WANG, Shenzhen (CN); Jianming FENG, Shenzhen (CN); Ming TANG, Shenzhen (CN); Mingda ZHU, Shenzhen (CN)

(73) Assignee: SMOORE INTERNATIONAL HOLDINGS LIMITED, Grand Cayman (KY)

(21) Appl. No.: 19/402,044

(22) Filed: Nov. 26, 2025

Related U.S. Application Data
(63) Continuation of application No. PCT/CN2024/089284, filed on Apr. 23, 2024.

(30) Foreign Application Priority Data
May 31, 2023 (CN) 202310640516.1

(51) Int. Cl. A24F 40/46; A24F 40/10; A24F 40/70; A24F 40/80

(52) U.S. Cl. CPC A24F 40/46; A24F 40/70; A24F 40/10; A24F 40/80

(57) ABSTRACT

The present disclosure provides an atomizing core, including a substrate, where a heating film is provided on the substrate. A tantalum thin-film is provided on the surface of the heating film away from the substrate. The heating film is made of elemental metal or an alloy material having a melting point of 1400° C. or more, and a resistivity of less than 5×10⁻⁷ Ωm. The resistance of the tantalum thin-film is at least five times the resistance of the heating film.

### RELATED APPLICATIONS

The present application is a continuation application of International application No. PCT/CN2024/089284, filed on Apr. 23, 2024, which claims priority to a Chinese Patent Application No. 202310640516.1, filed on May 31, 2023. The entire disclosure of the prior applications are hereby incorporated by reference.

### TECHNICAL FIELD

The present disclosure relates to an atomizing core and an atomizing device, and belongs to the technical field of electronic cigarettes.

### BACKGROUND

New electronic atomizing components often use thin-film type heating films to replace conventional thick films. The advantages of the thin-film type heating films are good material consistency and a thin film layer. Moreover, they do not fill the micro-pores on the heating surface of a porous substrate, so that the transmission speed of e-liquid is not be affected, and the higher atomizing efficiency can be achieved. However, if there is insufficient liquid supply during a process of heating and atomizing, the heating film may be dry-heated and the temperature may even reach 1000° C. or more, which may easily lead to a dry-heating failure of the heating film. On the other hand, atomizing is implemented by energizing the heating film for heating (where the potential difference is usually around 3 to 4 V). In addition, due to the wide variety of atomizing substrates, the compositions of which include some corrosive substances, and the operation temperature of the heating film reaches up to 300° C., the metal heating film is very susceptible to high-temperature electrochemical corrosion during the atomizing process, causing a corrosion failure of the heating film.

Although some existing heating thin-film materials has certain dry-heating resistance, as the atomizing temperature increases and the requirements for wet-heating life increase, these heating thin-films are very susceptible to corrosion under high-temperature electrochemical corrosion conditions, resulting in excessive resistance changes after long-term operation. Therefore, there is an urgent need to develop a long-life atomizing core structure that is resistant to both dry-heating and wet-heating.

### SUMMARY

The technical problem to be solved by the present disclosure is to provide an atomizing core, to solve the problem that existing atomizing cores lack the resistance to both dry-heating and wet-heating, and has a short service life. The present disclosure is implemented using the following technical solutions:

an atomizing core, including a substrate. A tantalum thin-film is provided on the surface of the heating film away from the substrate; where the heating film is made of elemental metal or an alloy material having a melting point of 1400° C. or more, and a resistivity of less than 5×10⁻⁷ Am; and the resistance of the tantalum thin-film is at least five times the resistance of the heating film.

The tantalum thin-film completely covers the surface of the heating film away from the substrate.

The resistance of the tantalum thin-film is 5 to 10 times the resistance of the heating film.

The alloys are metal alloys having a melting point of 1400° C. or more, and a resistivity of less than 5×10⁻⁷ Ωm.

The heating film is made of elemental metal or an alloy material having a melting point of 1400 to 4000° C. and a resistivity of 1×10⁻⁸ Ωm to 5×10⁻⁷ Ωm.

The thickness of the tantalum thin-film is 50 to 500 nm.

The thickness of the tantalum thin-film is 300 to 400 nm.

The tantalum thin-film is in a β-Ta crystal form.

The tantalum thin-film is made by a method of physical vapor deposition.

The thickness of the heating film is 300 to 5000 nm.

The heating film is made of at least one of elemental Ti, elemental Cr, elemental Mo, elemental Nb, Ti alloy, Cr alloy, Mo alloy, Nb alloy, and iron-based alloy material.

The heating film is made of stainless steel.

The heating film is a stainless steel heating film, and the thickness of the heating film is at least three times the resistance of the tantalum thin-film.

The heating film is a stainless steel heating film, and the thickness of the heating film is 3 to 20 times the resistance of the tantalum thin-film.

The heating film includes the following components by mass fraction:
Fe 67% to 72%, Cr 16% to 18%, Ni 10% to 12%, and Mo 2% to 3%.

The heating film includes the following components by mass fraction: Fe 67% to 72%, Cr 16% to 18%, Ni 10% to 12%, and Mo 2% to 3%, and the mass fraction of other elements is less than 1%.

The heating film is made by a method of physical vapor deposition.

A protective layer is provided on the surface of the tantalum thin-film away from the heating film.

The atomizing core further includes two pins, respectively provided on two opposite sides of the heating film and electrically connected to the heating film.

A protective layer is provided on the pins.

The protective layer is made of at least one of aluminum oxide, silicon oxide, aluminum oxynitride, and silicon oxynitride.

The protective layer is made by a method of physical vapor deposition or chemical vapor deposition.

The present disclosure further provides an atomizing device, including at least one of the foregoing atomizing cores.

Compared with the prior art, the present disclosure has the following technical effects:

The atomizing core of the present disclosure is provided with a heating film on a substrate. A tantalum thin-film is provided on the surface of the heating film away from the substrate; where the heating film is made of elemental metal or an alloy material having a melting point of 1400° C. or more, and a resistivity of less than 5×10⁻⁷ Ωm; and the resistance of the tantalum thin-film is at least five times the resistance of the heating film. Tantalum is one of the most chemically stable metal, and easily forms a layer of passive film on the surface, which has a very high resistance to electrochemical corrosion. It is particularly effective in isolating an electronic cigarette atomizing substrate from the heating thin-film, especially in substrate environments containing chloride ions. In addition, the heating film material uses elemental metal or an alloy material having a melting point of 1400° C. or more, and a resistivity of less than 5×10⁻⁷ Ωm, and the resistance of the tantalum thin-film is controlled to be at least five times the resistance of the heating film. This ensures that current mainly passes through a layer of the heating film having a low resistance. The tantalum thin-film does not generate much heat, and the heat is mainly concentrated at the end of the heating film. This configuration can effectively improve the high-temperature oxidation resistance of the heating film and the tantalum thin-film, enabling the entire atomizing core to have a strong resistance to dry-heating. In addition, the tantalum thin-film can significantly prevent the high-temperature electrochemical corrosion of a heating thin-film by an atomizing substrate, which improves the high-temperature wet-heating resistance and prolongs the service life. Therefore, the atomizing core of the present disclosure has strong resistance to both dry-heating and wet-heating, and is a long-life atomizing core.

### BRIEF DESCRIPTION OF THE DRAWINGS

FIG. 1 shows a schematic diagram of an atomizing core of Example 1;

Labels in the figure: 1. substrate, 2. heating film, 3. tantalum thin-film, 4. pin, and 5. protective layer.

FIG. 2 shows the wet-heating resistance change rate of a heating element of Example 1 (wet-heating with 1200 puffs).

FIG. 3 shows the wet-heating resistance change rate of a heating element of Comparative Example 1 (wet-heating with 1000 puffs).

### DETAILED DESCRIPTION

The present disclosure provides an atomizing core, including a substrate. A heating film is provided on the substrate. A tantalum thin-film is provided on the surface of the heating film away from the substrate. The melting point of the heating film is 1400° C. or more. The heating film is made of a material with a resistivity of less than 5×10⁻⁷ Ωm; and the resistance of the tantalum thin-film is at least five times the resistance of the heating film. Tantalum is one of the most chemically stable metal, and easily forms a layer of passive film on the surface, which has a very high resistance to electrochemical corrosion, especially substrate environments containing chloride ions. The tantalum thin-film in this type of atomizing core can effectively protect the heating film, significantly improving the capability of resisting wet-heating and extending the service life of the atomizing core. This type of atomizing core meets the following two conditions at the same time: the heating film material has a high melting point and a low resistivity; and the resistance of the tantalum thin-film is at least five times the resistance of the heating film. This ensures that current mainly passes through a layer of the heating film having a low resistance. The tantalum thin-film does not generate much heat, thereby improving its high-temperature oxidation resistance which can ensure compliance with the dry-heating resistance standards. In addition, the tantalum thin-film can significantly prevent the high-temperature electrochemical corrosion of a heating thin-film by an atomizing substrate, which improves the high-temperature wet-heating resistance and prolongs the service life. Therefore, the atomizing core of the present disclosure has strong resistance to both dry-heating and wet-heating, and is a long-life atomizing core.

In an optional embodiment, the tantalum thin-film completely covers the surface of the heating film away from the substrate. The resistance ratio of the tantalum thin-film to the heating film can be adjusted by varying the thickness of the tantalum thin-film. In an optional embodiment, the thickness of the tantalum thin-film is 50 to 500 nm. For example, the thickness of the tantalum thin-film is 50 nm, 100 nm, 150 nm, 200 nm, 250 nm, 300 nm, 350 nm, 400 nm, 450 nm, or 500 nm. The thickness of the tantalum thin-film may be 300 to 400 nm. A low thickness of the tantalum thin-film reduces the stress of the film layer itself. This may prevent cracking failure of the substrate protective layer due to fatigue thermal stress during a long-life operation.

In an optional embodiment, the tantalum thin-film is in a β-Ta crystal form. The tantalum thin-film in the β-Ta crystal form has a high resistivity (a resistivity of 2×10⁻⁶ Ωm) and does not generate much heat at the same thickness. In an optional embodiment, the heating film has a thickness of 1400 to 5000 nm. For example, the thickness of the tantalum thin-film is 1400 nm, 1500 nm, 1600 nm, 1700 nm, 1800 nm, 1900 nm, 2000 nm, 2500 nm, 3000 nm, 3500 nm, 4000 nm, 4500 nm, or 5000 nm. This type of heating film is a thin-film type heating film with a thickness below 5000 nm. In an optional embodiment, the tantalum thin-film is made by a method of physical vapor deposition.

In an optional embodiment, the heating film may be made of materials having a high melting point (1400 degrees Celsius or more) and a low resistivity (below 5×10⁻⁷ Ωm), such as elemental Ti, elemental Cr, elemental Mo, elemental Nb, alloy, etc. In an optional embodiment, the heating film is made of stainless steel. In an optional embodiment, the stainless steel heating film includes the following components by mass fraction: Fe 67% to 72%, Cr 16% to 18%, Ni 10% to 12%, and Mo 2% to 3%. In an optional embodiment, the heating film is a stainless steel heating film, and the thickness of the heating film is at least three times the resistance of the tantalum thin-film, to ensure that the resistance of the tantalum thin-film is at least five times the resistance of the heating film. In an optional embodiment, the heating film is made of materials such as elemental Ti, elemental Cr, elemental Mo, and elemental Nb, etc. This is because currently, due to the limitations of the resistivity and the thin-film thickness, the maximum aspect ratio of the stainless steel heating film can only reach 3:1, which imposes certain restrictions on heating pattern design. To increase the aspect ratio range of the heating film, elemental metal having a high melting point and a low resistivity may be selected as the heating film, and covered with a Ta layer, which can also ensure the dry-heating and wet-heating resistance of the heating film. In an optional embodiment, the heating film is made by a method of physical vapor deposition.

In an optional embodiment, a protective layer is provided on the surface of the tantalum thin-film away from the heating film. In an optional embodiment, the protective layer is made of at least one of insulating materials such as aluminum oxide, silicon oxide, aluminum oxynitride, and silicon oxynitride, etc. In an optional embodiment, the protective layer is made by using a method of physical vapor deposition or chemical vapor deposition. In an optional embodiment, the atomizing core further includes two pins, respectively provided on two opposite sides of the heating film and electrically connected to the heating film. The function of the pins is to energize the heating film for heating. In an optional embodiment, a protective layer is also provided on the pins. The protective layer reduces the corrosion of the tantalum thin-film, the heating film, and the pins by an electronic cigarette substrate.

The present disclosure further provides an atomizing device, including at least one of the foregoing atomizing cores. The following performance can be achieved by using the foregoing atomizing cores: the dry-heating performance of the heating film is >7.5 W (for a heating film area of 3.5 mm² porosity 20%, dry-heating in air for 10 cycles at a constant power of 7.5 W for energizing, with 3 s on and 8 s off, the resistance change of the heating film is <20%). The wet-heating performance of the heating film >1200 puffs (tested with strawberry watermelon ice e-liquid, 7.5 W puff for 3 s and stop for 15 s, the resistance changes not exceeding 21% after 1200 puffs).

The following examples are provided solely for the purpose of illustrating the present disclosure in more detail. The materials involved in these examples are all commercially available products. The following examples are provided to better further understand the present disclosure. These examples are not limited to the best embodiments, and do not constitute a limitation to the content and the scope of protection of the present disclosure. Any product identical or similar to the present disclosure obtained by anyone under the inspiration of the present disclosure or by combining the present disclosure with the features of other prior art shall fall within the scope of protection of the present disclosure.

A method for calculating the resistance ratio of the tantalum thin-film to the heating film in each example is as follows: measure the resistance of the single-layer heating film pattern as R1, and measure the combined resistance after the heating film is covered with the tantalum thin-film as R, then the resistance R2 of the tantalum thin-film is calculated by the following formula:

$$R 2 = R \times R 1 / ( R 1 - R ) ;$$

The resistance ratio of the tantalum thin-film to the heating film is calculated as R2/R1.

The methods for measuring the resistance change in each example and comparative example are as follows. The method for measuring the resistance change in the case of dry-heating: first, measure the initial resistance R0 of the heating film, then subject the heating film to dry-heating cycles in air for 10 cycles at a constant power of 7.5 W for energizing, with 3 s on and 8 s off, and measure the resistance R10 of the heating film after 10 cycles of dry-heating. The resistance change rate before and after dry-heating can be calculated as ΔR=(R10−R0)/R0.

The method for measuring the resistance change in the case of wet-heating: assemble a heating element into a cartridge and inject e-liquid, measure the initial resistance value R0 after assembly, select a battery with 7.5 W constant power to energize, with, and after 150 cycles of puffing, measure the resistance Rx of the heating film in the cartridge. The resistance change rate before and after wet-heating is calculated as ΔR=(Rx−R0)/R0.

The method of physical vapor deposition described in each example is as follows: using a magnetron sputtering apparatus to prepare a metal conductive layer via direct current (DC) sputtering method and prepare an insulating protective film via radio frequency (RF) method.

The strawberry watermelon ice flavored e-liquid in each example is: strawberry watermelon flavored e-liquid (40 mg) produced by Shenzhen Yupeng Technology Co., Ltd.

### Example 1

As shown in FIG. 1, this example provides an atomizing core including a heating substrate 1. The heating substrate has an array pore structure with a porosity of 20%. A heating film 2 made of 316 stainless steel was formed on the heating substrate by physical vapor deposition. The heating film 2 includes the following components by mass fraction: Fe about 70%, Cr about 16.5%, Ni about 10.5%, and Mo about 2.5%, and the remaining are unavoidable elements in the stainless steel such as C and S. The thickness of the heating film 2 is 1300 nm. A tantalum thin-film 3 was formed on the surface of the heating film 2 away from the substrate 1 by physical vapor deposition. The thickness of the tantalum thin-film is 300 nm.

A 316 stainless steel layer with a thickness of 50 nm and an Ag layer with a thickness of 2 μm were deposited on pins 4 on both sides of the heating film by physical vapor deposition, connecting the pins 4 to the heating thin-film.

A protective film 5 with a thickness of 100 nm was deposited on the pins and the surface of the tantalum thin-film.

An electronic cigarette atomizer was assembled using said atomizing core and further processed into an electronic cigarette. Dry-heating and wet-heating tests were conducted:

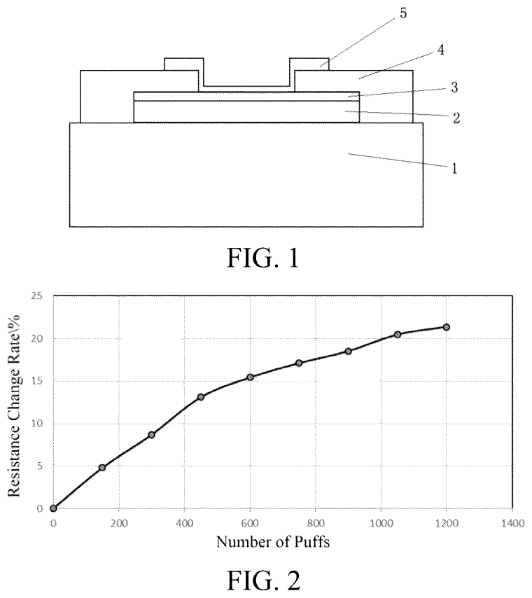

Dry-heating and wet-heating tests were conducted. Dry-heating capability: in the dry-heating, the resistance change was <20% after 10 puffs at 7.5 W (dry-heating in air at a constant power of 7.5 W for energizing, with 3 s on and 8 s off). Wet-heating capability: the resistance change was 21% after 1200 puffs with strawberry watermelon ice flavored e-liquid at 7.5 W (7.5 W puff for 3 s and stop for 15 s, capacity 55 mL). As shown in FIG. 2, the resistance increase in the heating element was relatively high before 600 puffs (detected mainly due to some electrochemical corrosion of the Ag pin). After 600 puffs, the resistance increase tended to level off, indicating that the high-temperature electrochemical corrosion of the heating film tended to halt.

### Comparative Example 1

The atomizing core in this comparative example was not provided with the tantalum thin-film on the heating thin-film. The rest was the same as that in the comparative example 1, using the same 316 stainless steel heating thin-film. An electronic cigarette atomizer was assembled using said heating thin-film structure and further processed into an electronic cigarette. Dry-heating and wet-heating tests were conducted:

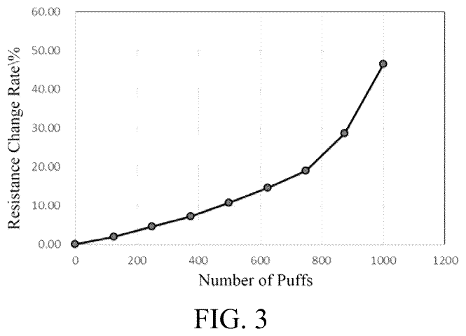

Dry-heating and wet-heating tests were conducted. Dry-heating capability: in the dry-heating, the resistance change was <20% after 10 puffs at 7.5 W (dry-heating in air at a constant power of 7.5 W for energizing, with 3 s on and 8 s off). Wet-heating capability: the resistance change was <20% after 750 puffs with strawberry watermelon ice flavored e-liquid at 7.5 W, and the resistance change increased dramatically to 46% from 750 puffs to 1000 puffs (7.5 W puff for 3 s and stop for 15 s, capacity 55 mL). As shown in FIG. 3, after 800 puffs, the resistance increase of the heating element became significantly sharp, indicating severe electrochemical corrosion of the heating film, resulting in a sharp increase in resistance.

In Examples 2 to 6 and Comparative Examples 2 to 7, the substrate, pore size, porosity, and dry-heating and wet-heating test conditions are all the same as those in Example 1, except that the heating film material, tantalum thin-film thickness, and protective layer thickness are changed. Related dry-heating and wet-heating test results are shown in Table 1.

TABLE 1
Dry-heating and Wet-heating Test Results

| | | | Tantalum | Substrate | | |
|---|---|---|---|---|---|---|
| | Heating | | Thin-film | Protective | | |
| | Film | | Resistance and | Film | | |
| | Thickness | Tantalum | Heating Film | Thickness | | |
| | (nm), | Thin-film | Resistance | (nm), | Dry-heating | Wet-heating |
| | Material | Thickness | Ratio | Material | Test Results | Test Results |
| Example 1 | 1300 nm | 300 nm | 9 | 100 nm | 7.5 W 10 puffs | 7.5 W 1200 |
| | 316 | | | Al₂O₃ | ΔR = 15% | puffs ΔR = 21% |
| | stainless | | | | | |
| | steel | | | | | |
| Comparative | 1300 nm | None | — | 100 nm | 7.5 W 10 puffs | 7.5 W 1000 |
| Example 1 | 316 | | | Al₂O₃ | ΔR = 10% | puffs ΔR = 46% |
| | stainless | | | | | |
| | steel | | | | | |
| Comparative | 1300 nm | 600 nm | 4.5 | 100 nm | 7.5 W 10 puffs | 7.5 W 1000 |
| Example 2 | 316 | | | Al₂O₃ | ΔR = 25% | puffs ΔR = 13% |
| | stainless | | | | | |
| | steel | | | | | |
| Example 2 | 350 nm | 500 nm | 6 | 300 nm | 6.5 W 10 puffs | 7.5 W 1200 |
| | Cr | | | Al₂O₃ | ΔR = 18% | puffs ΔR = 18% |
| Example 3 | 700 nm | 300 nm | 10 | 300 nm | 6.5 W 10 puffs | 7.5 W 1200 |
| | Ti | | | SiON | ΔR = 16% | puffs ΔR = 19% |
| Example 4 | 400 nm | 500 nm | 5.5 | 300 nm | 6.5 W 10 puffs | 7.5 W 1200 |
| | Mo | | | Al₂O₃ | ΔR = 18%, | puffs ΔR = 18% |
| | | | | | 7.5 W 10 puffs | |
| | | | | | ΔR = 30% | |
| Example 5 | 320 nm | 300 nm | 9 | 300 nm | 7.5 W 10 puffs | 7.5 W 1200 |
| | Nb | | | Al₂O₃ | ΔR = 19%, | puffs ΔR = 20% |
| Comparative | 350 nm | None | — | 300 nm | 5.5 W 10 puffs | 7.5 W 350 puffs |
| Example 3 | Cr | | | Al₂O₃ | ΔR = 18%, | ΔR = 25% |
| Comparative | 700 nm | None | — | 300 nm | 4.5 W 10 puffs | 7.5 W 400 puffs |
| Example 4 | Ti | | | Al₂O₃ | ΔR = 19%, | ΔR = 28% |
| | | | | | 5.5 W 10 puffs | |
| | | | | | ΔR = 33% | |
| Comparative | 400 nm | None | — | 300 nm | 5.5 W 10 puffs | 7.5 W 500 puffs |
| Example 5 | Mo | | | SiON | ΔR = 16%, | ΔR = 28% |
| | | | | | 6.5 W 10 puffs | |
| | | | | | ΔR = 25% | |
| Comparative | 320 nm | None | — | 300 nm | 6.5 W 10 puffs | 7.5 W 300 puffs |
| Example 6 | Nb | | | Al₂O₃ | ΔR = 17%, | ΔR = 26% |
| | | | | | 7.5 W 10 puffs | |
| | | | | | ΔR = 26% | |
| Comparative | 130 nm | 300 nm | 9 | 300 nm | 4.5 W 10 puffs | 7.5 W 1000 |
| Example 7 | Al | | | SiON | ΔR = 17%, | puffs ΔR = 16% |
| | | | | | 5.5 W 10 puffs | |
| | | | | | ΔR = 100% | |

It can be seen from the above experimental results that the provision of the tantalum thin-film can significantly improve the high-temperature wet-heating resistance of the atomizing core. It can be known from the results of Example 1 and Comparative Example 2 that when the tantalum thin-film thickness is too large, it leads to insufficient dry-heating resistance of the atomizing core. It can be known from the results of the Comparative Example 7 that when low-melting-point Al is used as the heating film, the dry-heating resistance of the atomizing core is very poor.

In summary, in the present disclosure, a tantalum thin-film is provided on a heating film with a high melting point (1400° C. or more) and a low resistivity (below 5×10⁻⁷ Ωm), with the resistance of the tantalum thin-film being at least five times the resistance of the heating film. It is possible to obtain an atomizing core that has a strong resistance to both dry-heating and wet-heating. This type of atomizing core has a long service life, with the dry-heating performance of the heating film >7.5 W, and the resistance change not exceeding 21% after 1200 puffs at 7.5 W.

Obviously, the above examples are merely illustrations for clear description and are not intended to limit the embodiments. For those of ordinary skill in the art, other different forms of variations or modifications based on the above descriptions are possible. It is not necessary and impossible to enumerate all embodiments herein. Obviously, variations or modifications arising therefrom remain within the scope of protection of the present disclosure.

What is claimed is:

1. An atomizing core comprising:
a substrate;
a heating film being provided on the substrate;
a tantalum thin-film being provided on a surface of the heating film away from the substrate, wherein a resistance of the tantalum thin-film is at least five times a resistance of the heating film; and
wherein the heating film is made of elemental metal or an alloy material having a melting point of 1400° C. or more, and a resistivity of less than 5×10⁻⁷ Ωm.

2. The atomizing core of claim 1, wherein a thickness of the tantalum thin-film is 50 to 500 nm.

3. The atomizing core of claim 2, wherein the thickness of the tantalum thin-film is 300 to 400 nm.

4. The atomizing core of claim 1, wherein the tantalum thin-film is in a β-Ta crystal form.

5. The atomizing core of claim 1, wherein the tantalum thin-film is made by a method of physical vapor deposition.

6. The atomizing core of claim 1, wherein a thickness of the heating film is 300 to 5000 nm.

7. The atomizing core of claim 1, wherein the heating film is made of at least one of elemental Ti, elemental Cr, elemental Mo, elemental Nb, Ti alloy, Cr alloy, Mo alloy, Nb alloy, and/or iron-based alloy material.

8. The atomizing core of claim 1, wherein the heating film is made of stainless steel.

9. The atomizing core of claim 8, wherein the heating film is a stainless steel heating film, and the thickness of the heating film is at least three times the resistance of the tantalum thin-film.

10. The atomizing core of claim 8, wherein the heating film comprises the following components by mass fraction:
Fe 67% to 72%, Cr 16% to 18%, Ni 10% to 12%, and Mo 2% to 3%.

11. The atomizing core of claim 1, wherein the heating film is made by a method of physical vapor deposition.

12. The atomizing core of claim 1, wherein a protective layer is provided on the surface of the tantalum thin-film away from the heating film.

13. The atomizing core of claim 12, wherein the protective layer is made of at least one of aluminum oxide, silicon oxide, aluminum oxynitride, and/or silicon oxynitride.

14. The atomizing core of claim 12, wherein the protective layer is made by a method of physical vapor deposition or chemical vapor deposition.
